(19) United States
(12) Patent Application Publication
(10) Pub. No.: US 2002/0186489 A1
(43) Pub. Date: Dec. 12, 2002

(54) Design algorithm for high bandwidth actuator

(76) Inventors: Girish Naganathan, Longmont, CO (US); Paul Lee, Boulder, CO (US); Steven Rey Speckman, Louisville, CO (US); Alexander W. Chang, Longmont, CO (US)

Correspondence Address: Derek Berger, Seagate Technology LLC, Intellectual Property - COL2LGL, 389 Disc Drive, Longmont, CO, 80503, US

(21) Appl. No.: 10/170,054

(22) Filed: Jun. 10, 2002

Related U.S. Application Data
(60) Provisional application No. 60/297,158, filed on Jun. 8, 2001.

(51) Int. Cl. G11B 5/02

(52) U.S. Cl. 360/55

(57) ABSTRACT

Disclosed is a design methodology which facilitates increasing the system mode frequency of an actuator system. As a first step, the primary components of a given actuator system are analyzed to determine which component is most responsible for limiting the system mode frequency of the given system. That component is then stiffened, resulting in a new actuator system with a higher system mode frequency. A second analysis step may then be performed to determine whether the modified design is optimal. These steps may be repeated as parts of an iterative process resulting in an optimal actuator design.

### CROSS REFERENCE TO RELATED APPLICATION

This application claims the benefit of U.S. Provisional Application No. 60/297,158, filed Apr. 8, 2001.

### FIELD OF THE INVENTION

This invention relates generally to the field of hard disc drive data storage devices, and more particularly, but not by way of limitation, to disc drive actuators.

### BACKGROUND OF THE INVENTION

Disc drives of the type known as “Winchester” disc drives, or hard disc drives, are well known in the industry. Such disc drives magnetically record digital data on a plurality of circular, concentric data tracks on the surfaces of one or more rigid discs. The discs are typically mounted for rotation on the hub of a brushless DC spindle motor. In disc drives of the current generation, the spindle motor rotates the discs at speeds of up to 15,000 RPM.

Data are recorded to and retrieved from the discs by an array of vertically aligned read/write head assemblies, or heads, which are controllably moved from track to track by an actuator assembly. The read/write head assemblies typically consist of an electromagnetic transducer carried on an air bearing slider. This slider acts in a cooperative pneumatic relationship with a thin layer of air dragged along by the spinning discs to fly the head assembly in a closely spaced relationship to the disc surface. In order to maintain the proper flying relationship between the head assemblies and the discs, the head assemblies are attached to and supported by flexures attached to the actuator.

The actuator assembly used to move the heads from track to track has assumed many forms historically, with most disc drives of the current generation incorporating an actuator of the type referred to as a rotary voice coil actuator. A typical rotary voice coil actuator consists of a pivot shaft fixedly attached to the disc drive housing base member closely adjacent the outer diameter of the discs. The pivot shaft is mounted such that its central axis is normal to the plane of rotation of the discs. The actuator is mounted to the pivot shaft by precision ball bearing assemblies within a bearing housing. The actuator supports a flat coil which is suspended in the magnetic field of an array of permanent magnets, which are fixedly mounted to the disc drive housing base member. These magnets are typically mounted to pole pieces which are held in positions vertically spaced from another by spacers at each of their ends.

On the side of the actuator bearing housing opposite to the coil, the actuator assembly typically includes a plurality of vertically aligned, radially extending actuator head mounting arms, to which the head suspensions mentioned above are mounted. These actuator arms extend between the discs, where they support the head assemblies at their desired positions adjacent the disc surfaces. When controlled DC current is applied to the coil, a magnetic field is formed surrounding the coil which interacts with the magnetic field of the permanent magnets to rotate the actuator bearing housing, with the attached head suspensions and head assemblies, in accordance with the well-known Lorentz relationship. As the actuator bearing housing rotates, the heads are moved generally radially across the data tracks of the discs along an arcuate path.

As explained above, the actuator assembly typically includes an actuator body that pivots about a pivot mechanism disposed in a medial portion thereof. The function of the pivot mechanism is crucial in meeting performance requirements associated with the positioning of the actuator assembly. A typical pivot mechanism has two ball bearings with a stationary shaft attached to an inner race and a sleeve attached to an outer race. The sleeve is also secured within a bore in the actuator body. The stationary shaft typically is attached to the base deck and the top cover of the disc drive.

As disc drive consumers demand ever higher storage capacity and data access speeds, track densities have increased to the point at which a single 3.5 inch disc can store over 40 gigabytes of data. Track densities are projected to increase far beyond these numbers. Because tracks are increasingly smaller and closer together, it is more important than ever that the actuator and servo system be designed so as to minimize undesirable actuator movement caused by vibration and external disturbances.

Undesirable actuator movement is exacerbated by resonance within a vibrating actuator system. All moving mechanical systems are characterized by natural resonance frequencies. When an actuator vibrates in a particular mode at a frequency equal to the resonant frequency of that mode, the vibrations intensify until the servo system can no longer effectively control actuator movement. It is therefore generally desirable that an actuator system be designed such that the resonant frequencies in each mode are as high as possible so as to prevent resonance within the actuator system.

An actuator system has a number of bending modes, each having a resonant frequency a designer must be concerned with. For example, one such bending mode, conventionally known as a “bending mode,” involves bending of the actuator arm out of the rotational plane of the actuator, where the bending takes place near the pivot cartridge. Another bending mode is known as the “torsion mode,” in which the actuator arm twists about a longitudinal axis of the actuator arm, such that the plane of the actuator intersects but is no longer parallel to the rotational plane of the actuator.

Another bending mode of primary concern is the “system mode,” in which the actuator arm and coil support bend in the same lateral direction within the rotational plane of the actuator, while the bearing also translates laterally in this same direction. This mode is also known as either the “butterfly mode.” In this mode, as the servo system directs the actuator to move the head from track to track, the actuator will vibrate. A lack of stiffness of the arm, tail and bearing assembly causes them to move together from side to side within the actuator plane. As long as the frequencies generated by the servo system remain below the various resonant frequencies of the actuator, the drive will continue to function properly. It should be clear that the speed at which the drive may operate is limited by the resonant frequencies of the actuator system. It is generally a goal of actuator design, therefore, to raise the natural resonant frequencies of the actuator system to allow for faster drive operation.

This has typically been accomplished by attempting to maximize the stiffness of the actuator assembly. In the past, attempts were made to attack the entire actuator system, by stiffening the actuator arm, the coil support, and the actuator pivot bearing assembly. The arm and coil support, for example, could be thickened, while the bearing stiffness could be increased by raising the preload on the bearings. However, it has often been found that stiffening one of these elements does not cause the resonance frequency in of system mode to be raised significantly. Often stiffening one element merely raises the rotational inertia of the assembly, thereby lengthening seek and settle times while failing to reduce resonance. In addition, failure to stiffen each element of the actuator system an appropriate amount can limit the extent to which the resonant frequency can be raised.

What the prior art has been lacking is a simple actuator system design methodology which optimizes stiffening of an actuator system so as to raise the resonant frequency to the greatest degree possible without unduly increasing the rotational inertia of the system and while minimizing undue experimentation.

### SUMMARY OF THE INVENTION

The present invention is directed to a design methodology which facilitates increasing the system mode frequency of an actuator system. As a first step, the primary components of a given actuator system are analyzed to determine which component is most responsible for limiting the system mode frequency of the given system. That component is then stiffened, resulting in a new actuator system with a higher system mode frequency. A second analysis may then be performed to determine whether the modified design is optimal. These steps may be repeated as parts of an iterative process resulting in an optimal actuator design.

### BRIEF DESCRIPTION OF THE DRAWINGS

FIG. 1 shows an exploded view of a disc drive incorporating the actuator design methodology of the present invention.

FIG. 2 shows a perspective view of an actuator incorporating the bearing mounting assembly of the present invention.

FIG. 3 shows a perspective view of another actuator incorporating the bearing mounting assembly of the present invention.

FIG. 4 depicts a cross-sectional view of a pivot bearing assembly.

FIG. 5 depicts an actuator arm in a sway mode.

FIG. 6 shows a plot of system mode frequency vs. normalized arm stiffness in accordance with one embodiment of the invention.

FIG. 7 shows a plot of system mode frequency vs. normalized bearing preload in accordance with one embodiment of the invention.

FIG. 8 shows a plot of system mode frequency vs. normalized coil support stiffness in accordance with one embodiment of the invention.

FIG. 9 shows a plot of normalized system mode frequency vs. normalized arm stiffness in accordance with one embodiment of the invention.

FIG. 10 shows a plot of normalized system mode frequency vs. normalized bearing preload in accordance with one embodiment of the invention.

FIG. 11 shows a plot of system normalized mode frequency vs. normalized coil support stiffness in accordance with one embodiment of the invention.

### DETAILED DESCRIPTION OF THE INVENTION

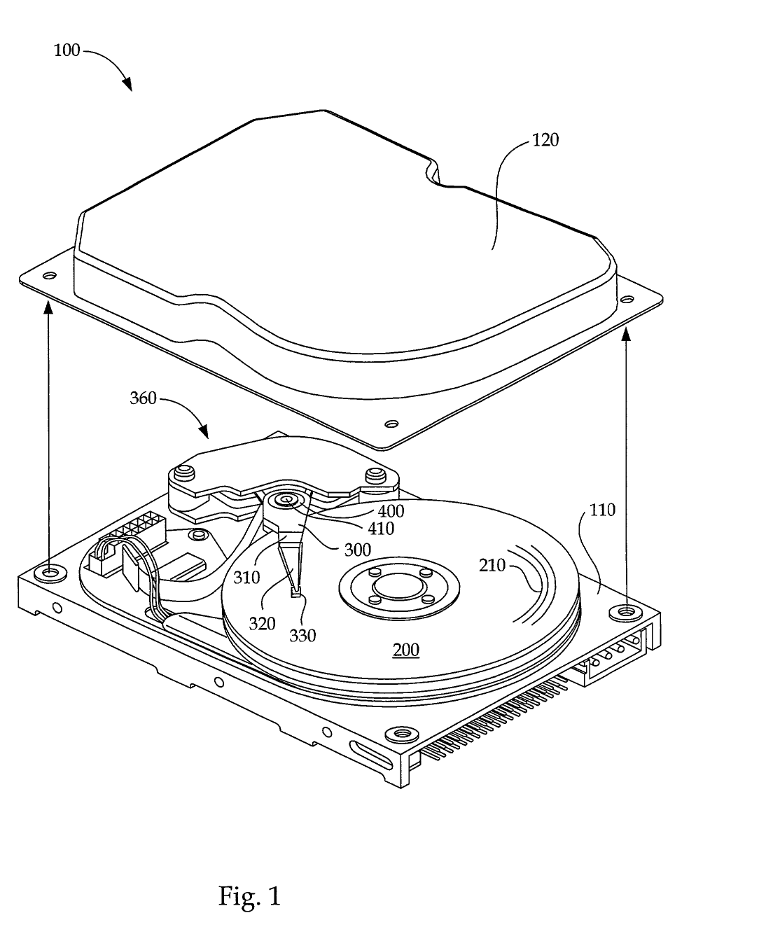

Turning now to the drawings and specifically to FIG. 1, shown is an exploded view of an example of a disc drive 100 in which the present invention is particularly useful. The disc drive 100 includes a deck 110 to which all other components are directly or indirectly mounted and a top cover 120 which, together with the deck 110, forms a disc drive housing which encloses delicate internal components and isolates these components from external contaminants.

The disc drive 100 includes a plurality of discs 200 which are mounted for rotation on a spindle motor (not shown). The discs 200 include on their surfaces a plurality of circular, concentric data tracks 210 on which data are recorded via an array of vertically aligned head assemblies (one of which is shown at 330). The head assemblies 330 are supported by flexures 320, which are attached to arms 310 of actuator 300. The actuator 300 is mounted to a bearing assembly 400 which includes a stationary pivot shaft 410 about which the actuator 300 rotates.

Power to drive the actuator 300 about the pivot shaft 410 is provided by a voice coil motor (VCM). The VCM includes a coil 350 which is supported by the actuator 300 within the magnetic field of a permanent magnet assembly 360 having spaced upper and lower magnets. Electronic circuitry is provided on a printed circuit board (PCB, not shown) mounted to the underside of the deck 110. Control signals to drive the VCM are carried between the PCB and the moving actuator 300 via a flexible printed circuit cable (PCC), which also transmits data signals to and from the heads 330.

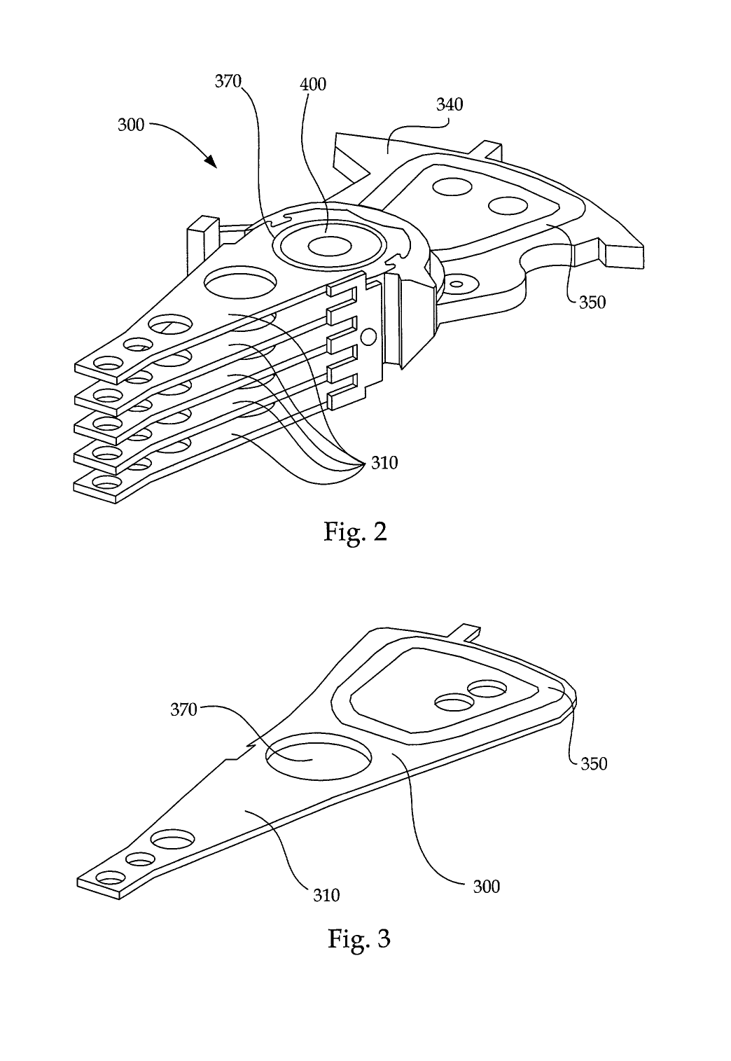

The actuator 300 may take a variety of different forms. FIG. 2 shows one such actuator 300, which includes a metal portion forming a number of arms 310 and a coil support portion 330 for mounting coil 340. The metal portion is often formed of aluminum, but could of course be formed from any number of materials. The coil support portion 340 here is illustrated as a plastic portion, also called an overmold, which covers part of the aforementioned metal portion as well as the coil 350. Of course the coil support portion could also be metallic and formed unitarily with the arms 310, with the coil bonded to the support portion by an adhesive or some other suitable means.

FIG. 3 depicts yet another form the actuator 300 may take. In this embodiment, the actuator 300 is a single planar member having a single arm 310. This member may stamped from a metal such as aluminum or may be formed from some other lightweight material such as plastic or some or even a substrate such as a printed circuit board. In any case, the coil 350 may again be bonded directly to the stamped member or formed within the material during its formation.

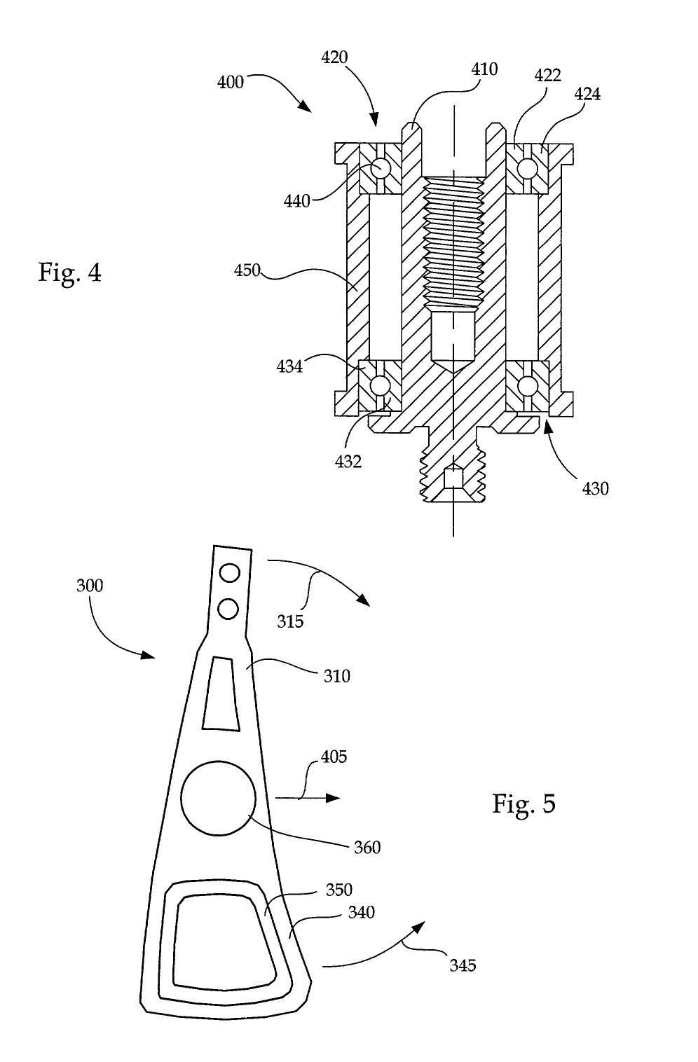

FIG. 4 shows a typical bearing assembly 400, which has upper and lower ball bearing assemblies 420,430 having balls 440 which roll between inner races 422,432 and outer races 424,434. Stationary shaft 410 is fixed to the inner races 422,432 and a rotating sleeve 450 is attached to the outer races 424,434 which are free to rotate about the inner races 422,432. The sleeve 450 is typically secured within a bore 370 in the actuator body and the stationary shaft typically is attached to the base deck and the top cover of the disc drive. The bearings 420,430 are preloaded such that the inner races 422,432 are forced toward one another. The inner races 422,432 and outer races 424,434 of each pivot assembly 400 are thereby slightly offset so as to take up radial clearances built into the pivot assemblies.

FIG. 5 shows a view from above of an actuator 310 vibrating in the system mode. In this exaggerated drawing, it can be seen that in the system mode, the distal end of arm 310 moves in the same lateral direction, depicted by arrow 315, as coil support portion 340, which moves as depicted by arrow 345. The pivot bearing also translates laterally as depicted by arrow 405. These portions oscillate back and forth in the system mode.

As vibration in the system mode approaches the resonant frequency of the actuator system, vibrations will increase until the actuator system is no longer stable, leading to an inability of the actuator 300 to properly position the heads 330 over a given track 210, and will also impair the ability of the actuator 300 to allow the heads 330 to follow a given track 210. It has therefore been a goal generally to raise the resonant frequency in any given mode. Through testing and/or modeling, the system mode frequency of a given actuator system can be determined. The resonant frequencies are typically raised by increasing the stiffness of the system. In the past, stiffness was raised by, for example, stiffening the arm 310 or coil support 340. However, merely thickening actuator portions will also significantly increase the rotational inertia of the actuator system. Moreover, for reasons set forth below, stiffening one portion of the actuator system may do little to increase the overall stiffness of the actuator system. The result is often that rotational inertia is increased, increasing seek times, while resonant frequencies are not raised to a significant degree.

This is particularly true with respect to the system mode, where overall lateral stiffness is affected by the various components of the actuator system, each having a different lateral stiffness which contributes to overall lateral stiffness. In the system mode, there are three primary components of the actuator system which contribute to overall lateral stiffness: (1) the actuator arm or arm assembly; (2) the actuator coil support or overmold; and (3) the actuator bearing assembly. Each of these elements has its own lateral stiffness.

In the past, optimization of an actuator system with respect to the system mode was a very time-consuming, labor-intensive endeavor. One way of doing this, of course, was to measure vibration in an actual actuator system in use to determine the system mode frequency. This would be followed by a modification to the actuator design in order to stiffen it, followed by more testing and measurement until a desirable design was achieved. Now, modeling is generally used, where all structural details as well as material properties are entered into a computer. The computer may then be used to calculate a variety of details about the actuator system, including the system mode frequency. The actuator system as understood by the computer may then be modified and a new system mode frequency determined. However, repeated entry of varying actuator structure is also time-consuming, and is still often nothing more than a trial-and-error, hit-or-miss procedure.

In one embodiment of the present invention, optimization of an actuator system is a two-step process. The first step involves identifying the actuator system component which is actually limiting the system mode frequency. Once this is identified, the designer may focus on modifications to this component in an effort to raise the system mode frequency. The second step involves stiffening that component and then analyzing it in order to determine the degree to which the system mode frequency has been raised. The result is an improved actuator system with a higher system mode frequency. Step one may then be repeated to determine which component of this new actuator should be stiffened, after which the second step may also be repeated. This may form part of an iterative process which continually improves the actuator system until a satisfactory design is achieved. This embodiment of the invention also provides a method for determining when the actuator design is satisfactorily optimized.

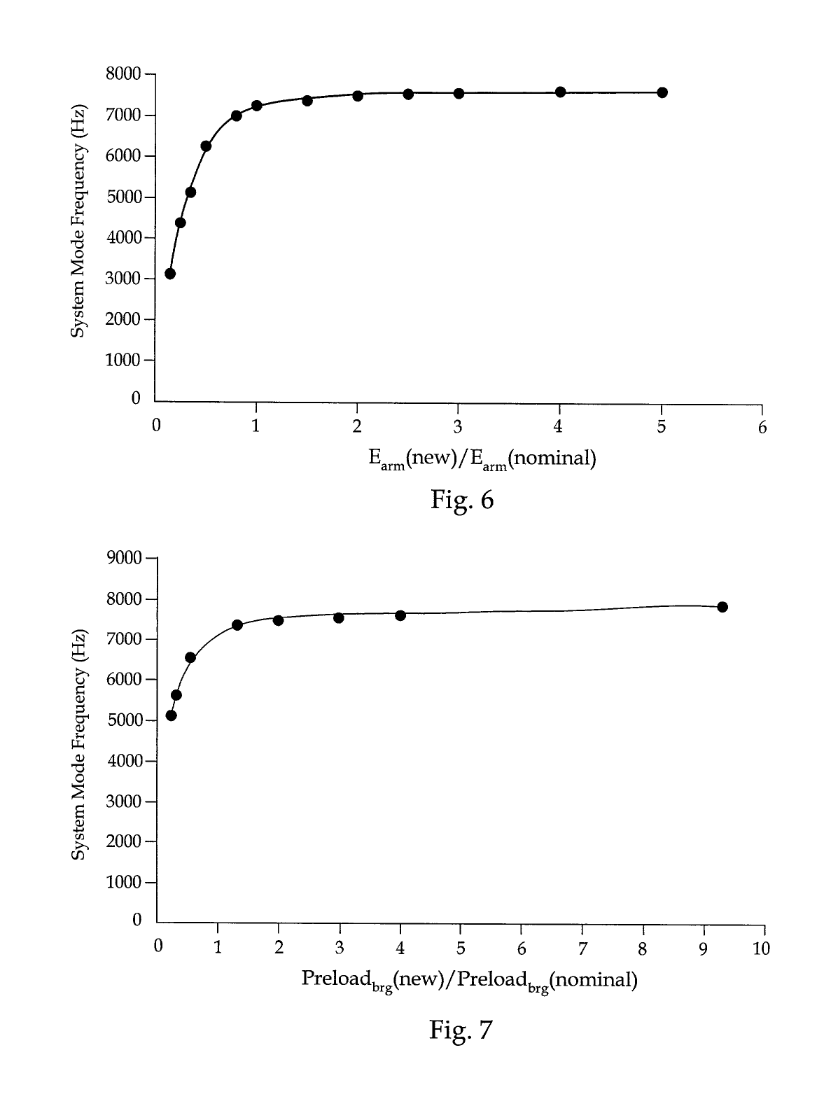

FIGS. 6-8 illustrate an example of the first step of this analysis with respect to a hypothetical actuator system. FIG. 6 plots out modifications in arm stiffness. The vertical axis of the plot is the system mode frequency, or the frequency at which the actuator system will resonate in the system mode. The horizontal axis plots out a normalized stiffness which is calculated by dividing a proposed change in stiffness by the stiffness of the arm of the nominal actuator system, or Eₐᵣₘ(new)/Eₐᵣₘ(nominal). E, also known as Young's modulus or modulus of elasticity, is used to vary the stiffness for modeling purposes because of the ease with which this material property may be varied within the computer model. Eₐᵣₘ(nominal) represents the stiffness of the arm for a given actuator system, while Eₐᵣₘ(new) represents a modified stiffness. As can be seen from FIG. 6, the system mode frequency of this particular actuator system is approximately 7200 Hz, (i.e., where Eₐᵣₘ(new)/Eₐᵣₘ(nominal)=1). It can also be seen that the increase in system mode frequency is generally asymptotic; that is, no matter how much we increase the stiffness of the arm, it will not be possible to raise the system mode frequency above about 7600 Hz for this given hypothetical design.

Similarly, FIG. 7 depicts a plot of the system mode frequency for the same actuator system where bearing stiffness is varied. Stiffness here is measured by the amount of preload applied to a conventional pivot bearing assembly, again because this factor is easily varied within a computer model. It should be clear that the system mode frequency of the present actuator system is about 7200 Hz (where preload_{brg}(new)/preload_{brg}(nominal)=1). Again, the increase in system mode frequency is seen to be asymptotic in that no matter how much we increase the stiffness of the arm, it will not be possible to raise the system mode frequency above about 7600 Hz for this design, the same as the asymptotic limit observed for the arm analysis of FIG. 6.

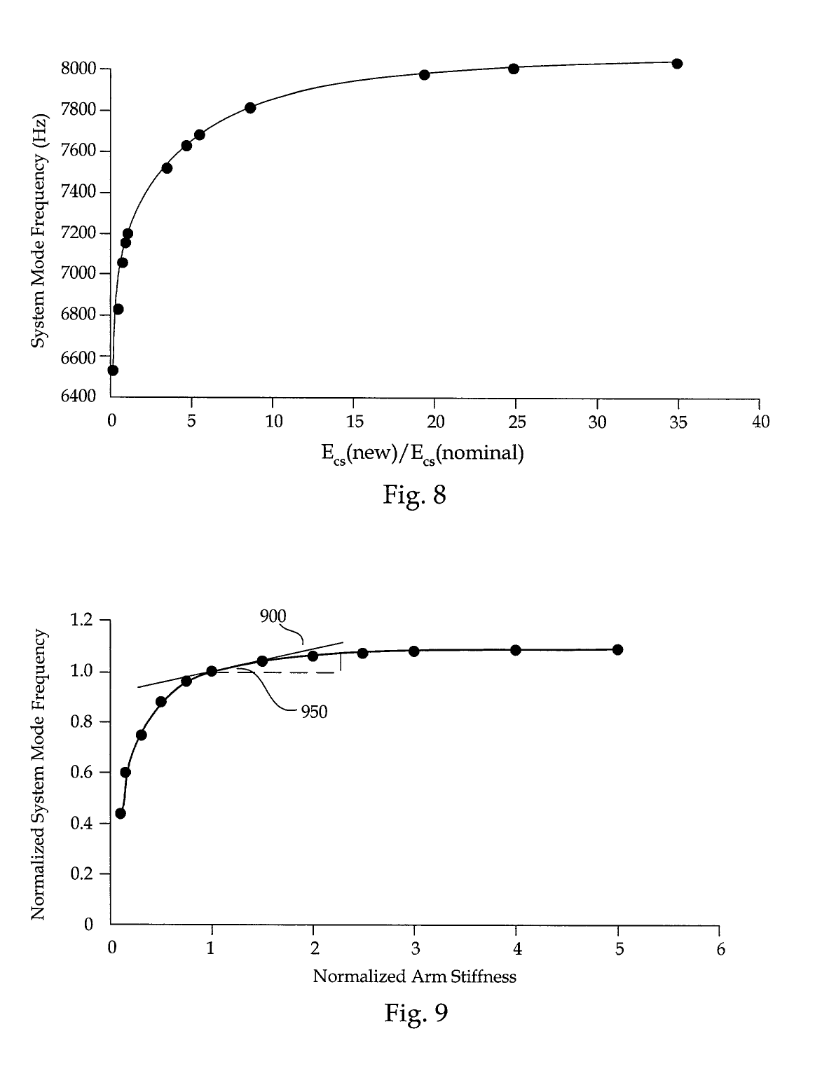

FIG. 8 depicts a plot of the system mode frequency for the same actuator system where coil support stiffness is varied. We again choose E as an indicator of stiffness for its ease of variation within the computer model. Again, it should be clear that the system mode frequency of the present actuator system is about 7200 Hz (where E_{cs}(new)/E_{cs}(nominal)=1). It is also clear that rise in system mode frequency is asymptotic. However, it can be seen that the upper limit here is significantly higher that it was when we modeled the increase in arm or bearing stiffness. Increasing the stiffness of the coil support yields a possible rise in system mode frequency to over 8000 Hz for this design, much higher than the asymptotic limit observed for the analyses of the arm and bearing assembly.

This first step has taught us that for this particular hypothetical actuator system, the coil support is the limiting factor when trying to increase the system mode frequency. This means that any attempt to raise the system mode frequency by stiffening either the arm or the pivot assembly will fail until we first address our weakest link, the low stiffness of the coil support. This means stiffening the coil support so that the second step of analysis can be initiated.

The second step of analysis involves determining whether the component identified in the first step of the actuator system has been sufficiently stiffened such that the resulting actuator system is optimal. This is accomplished by analyzing changes in the system mode frequency with respect to changes in the stiffness of each actuator system component as modified per the first step. FIGS. 9-11 illustrate how this step is implemented in the case of our hypothetical modified actuator system.

FIG. 9 depicts a plot of normalized system mode frequency vs. normalized actuator arm stiffness for a given, or nominal actuator system design having a nominal system mode frequency freq(nominal) and a nominal arm stiffness, represented by Eₐᵣₘ(nominal) (Young's modulus). In this case, “nominal” refers to our original hypothetical system as modified after performing the first analysis step set forth above. First, actuator system performance is modeled by varying the arm stiffness parameter Eₐᵣₘ(new), a new system mode frequency freq(new) being determined for each new arm stiffness Eₐᵣₘ(new). The normalized arm stiffness is then obtained by dividing Eₐᵣₘ(new) by Eₐᵣₘ(nominal), while the normalized system mod frequency is obtained by dividing freq(new) by freq(nominal). The points are plotted as shown in FIG. 9. Point (1,1) of the plot, of course, represents the arm stiffness and system mode frequency of the nominal actuator system design.

It is desirable that the nominal arm design be located at a point at which the plotted curve is becoming asymptotic. The reason for this is twofold. First, where the curve of FIG. 9 is becoming asymptotic, it should be clear that increases in arm stiffness have very little effect when it comes to increasing the system mode frequency. The diminishing returns indicate that further stiffening would be unnecessary. Second, where the curve is becoming asymptotic, minor deviations in arm construction due to manufacturing tolerances will also result in very little change in system mode frequency. The determination as to whether the curve has become asymptotic is made by first plotting a tangent 900 at point (1,1). The angle 950 of this tangent 900 with respect to horizontal is indicative of whether this is the case. In one embodiment of the invention, angle 950 is preferably less than 10 degrees, although it is conceivable that certain applications might require a more stringent or less stringent standard. Angle 950 may be determined by any generally acceptable method. For example, the plot could be modeled as an equation and a derivative taken to determine the slope of the tangent 900. The curve and tangent could also be physically plotted and the tangent slope measured and calculated. In FIG. 9, if angle 950 is less than 10 degrees, the nominal arm would be considered optimal for our purposes. Of course, if the angle 950 is to be physically measured, differences in scale between the vertical and horizontal axes must be taken into account.

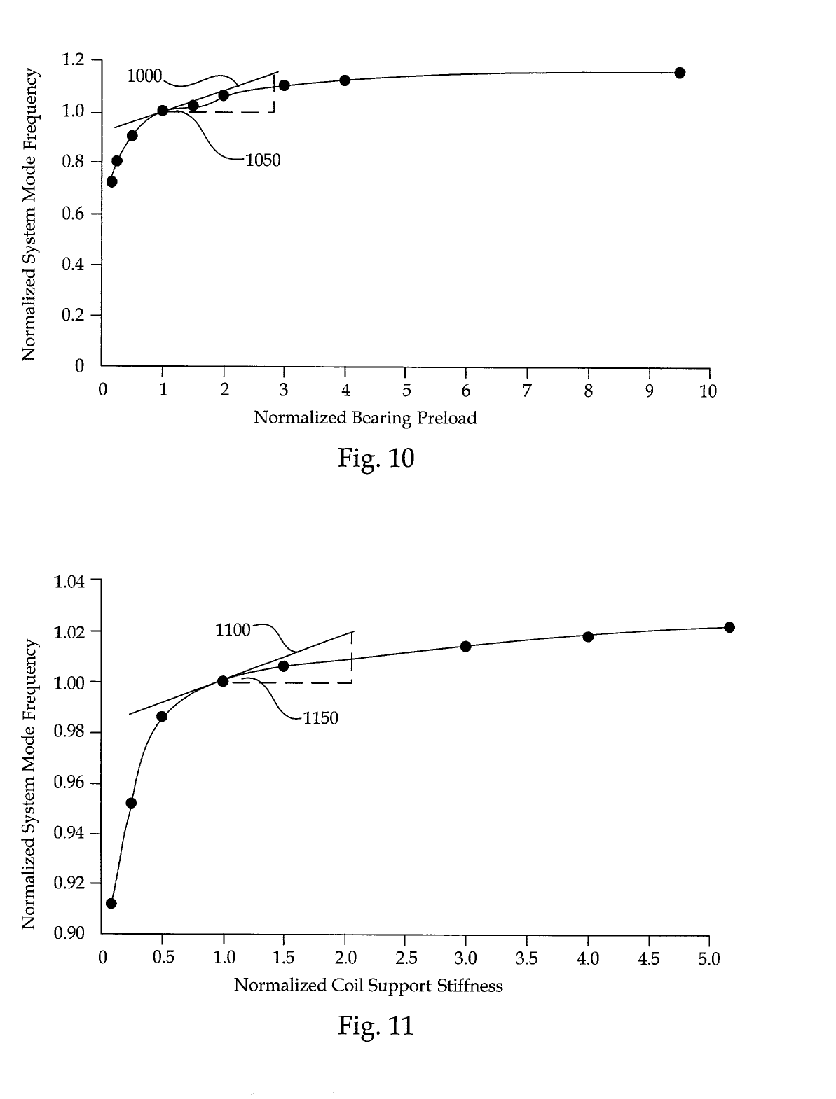

Similarly, FIG. 10 depicts a plot of normalized system mode frequency vs. normalized bearing stiffness. First, performance of the modified hypothetical actuator system is modeled by varying the bearing preload parameter (preload(new)), a new system mode frequency freq(new) being determined for each new bearing preload (preload(new)). The normalized bearing preload is then obtained by dividing preload(new) by preload(nominal), while the normalized system mode frequency is obtained by dividing freq(new) by freq(nominal). The points are plotted as shown in FIG. 10. Point (1,1) of the plot, of course, represents the bearing preload and system mode frequency of the nominal actuator system design. A tangent 1000 is again plotted at point (1,1), and the angle 1050 of this tangent 1000 with respect to horizontal is determined. Again, if angle 1050 is less than 10 degrees, the nominal bearing preload would be considered optimal for our purposes.

Similarly, FIG. 11 depicts a plot of normalized system mode frequency vs. normalized coil support stiffness. First, performance of the modified hypothetical actuator system is modeled by varying the coil support stiffness parameter E_{cs}(new), a new system mode frequency freq(new) being determined for each new coil support stiffness E_{cs}(new). The normalized coil support stiffness is then obtained by dividing E_{cs}(new) by E_{cs}(nominal), while the normalized system mode frequency is obtained by dividing freq(new) by freq(nominal). The points are plotted as shown in FIG. 11. Point (1,1) of the plot, of course, represents the coil support stiffness and system mode frequency of the nominal actuator system design. A tangent 1100 is again plotted at point (1,1) and the angle 1150 of this tangent 1100 with respect to horizontal is determined. Again, if angle 1150 is less than 10 degrees, the nominal coil support stiffness would be considered optimal for our purposes.

If any of the tangents 950, 1050, 1150 lie at an angle exceeding 10 degrees, it will be necessary to repeat the two-step process, again first identifying the weakest component and stiffening it, and secondly, analyzing an actuator system so modified to determine whether the system is optimal. The process may be repeated numerous times, each a part of an iterative process designed to selectively stiffen system components as necessary to reach an optimal design.

The process for analyzing an actuator system in which the arm 310 is of a substantially different structure than the coil support 340 has just been described. Such an actuator system is depicted in FIG. 2, where the coil support 340 takes the form of a plastic overmold. The process can be simplified where the actuator 300 is a simple planar actuator such as the one depicted in FIG. 3. This is because when stiffness variations are modeled in both the arm 310 and coil support 340, only Young's modulus, or E, is varied. In the planar actuator 300, the arm 310 and the coil support 340 are generally formed from the same material. The process for analyzing a planar actuator 300 is simplified because modeling of the coil support 340 is unnecessary.

As with the analysis of the overmolded actuator, the first step in analyzing a planar actuator involves modeling stiffness variations for the purpose of determining which component is limiting the rise in system mode frequency. The system mode frequency is then plotted on a vertical axis and a normalized stiffness is plotted on the horizontal axis, producing plots similar to those shown in FIGS. 6 and 7. However, a plot corresponding to FIG. 8 would be unnecessary. Once the limiting component is identified and stiffened, the second analysis step takes place and stiffness variations are modeled. The normalized system mode frequency is then plotted on a vertical axis and a normalized stiffness is plotted on the horizontal axis, producing plots similar to those shown in FIGS. 9 and 10. However, a plot corresponding to FIG. 11 would be unnecessary. Again however, tangents are plotted at point (1,1) of each plot and the design deemed optimal where the angle between the tangent and horizontal is less than 10 degrees on each of the two plots.

It should also be noted that where the pivot bearing assembly 400 is noted to be the limiting component as a result of the first step of analysis, it is likely that the actuator system design is already optimal, eliminating the need for the second step of analysis. This is because the pivot assemblies are typically preformed with a designated preload designed to balance stiffness and rotational freedom. In other words, while raising preload would increase stiffness, it would also increase the friction between the balls 440 and races 420,430 to an undesirable level, reducing drive performance. Of course, it is conceivable that other bearing designs could be implemented, such as point bearings or flexural pivots, which would reduce the friction/preload problem posed by conventional pivot assemblies.

It should also be noted that while the design method disclosed above is described with respect to the system mode, that it could be applied to any mode in which the resonant frequency is dependent upon the stiffness of two or more components. It is also contemplated that this analysis could be applied in contexts outside of disc drives, and even outside of the data storage industry, as long as, again, a system having two or more components is subject to risk of vibrations reaching a resonant frequency.

From the foregoing, it is apparent that the present invention is particularly suited to provide the benefits described above. While particular embodiments of the invention have been described herein, modifications to the embodiments which fall within the envisioned scope of the invention may suggest themselves to one of skill in the art who reads this disclosure.

What is claimed is:

1. A method for raising a resonant frequency of an actuator system design having at least two components each having an initial stiffness, the method comprising steps of:
(a) determining a first maximum to which the resonant frequency may be raised by stiffening a first of the components;
(b) determining a second maximum to which the resonant frequency may be raised by stiffening a second of the components;
(c) stiffening either the first component or the second component depending upon the determinations of the first and second maximums.

2. The method of claim 1 in which in step (c), the first component is stiffened if the first maximum is determined to be greater than the second maximum, but the second component is stiffened if the second maximum is determined to be greater than the first maximum.

3. The method of claim 1, in which the at least two components comprises three components.

4. The method of claim 1, in which the actuator system is configured for use in a disc drive.

5. The method of claim 1, in which the first component comprises an actuator arm having an end configured to support a transducer.

6. The method of claim 5, in which the second component comprises a pivot assembly configured to rotatably support the actuator arm.

7. The method of claim 6, in which the at least two components comprises a third component, the third component comprising a coil support portion.

8. The method of claim 1, in which determining step (a) further comprises steps of:
(a)(1) varying the stiffness of the first component;
(a)(2) plotting the resonant frequency with respect to the varying stiffness.

9. The method of claim 8 in which determining step (b) further comprises steps of:
(b)(1) varying the stiffness of the first component;
(b)(2) plotting the resonant frequency with respect to the varying stiffness.

10. The method of claim 1, further comprising a step of:
(d) after stiffening step (c), determining whether the actuator system design is optimal.

11. The method of claim 11, in which determining step (d) further comprises steps of:
(d)(1) varying the stiffness of the first component;
(d)(2) determining the resonant frequency at each varied stiffness of the first component;
(d)(3) normalizing the varied stiffness of the first component;
(d)(4) normalizing the resonant frequency; and
(d)(5) plotting the normalized resonant frequency with respect to the normalized stiffness of the first component.

12. The method of claim 10, in which determining step (d) further comprises a step of:
(d)(6) varying the stiffness of the second component;
(d)(7) determining the resonant frequency at each varied stiffness of the second component;
(d)(8) normalizing the varied stiffness of the second component; and
(d)(9) normalizing the resonant frequency.
(d)(10) plotting the normalized resonant frequency with respect to the normalized stiffness of the second component.

13. The method of claim 11, in which determining step (d) further comprises steps of:
(d)(6) determining a slope of a tangent line at point 1,1 of the plot of normalized resonant frequency with respect to the normalized stiffness of the first component; and
(d)(6) comparing the slope of the tangent line to a predetermined slope.

14. The method of claim 13, in which the predetermined slope is equal to 10 degrees from horizontal.

15. An apparatus, comprising:
a base; and
an actuator designed by the method of claim 1.

16. The apparatus of claim 15, further comprising:
at least one rotatable disc.
